(19) United States
(12) Patent Application Publication
(10) Pub. No.: US 2020/0293494 A1
(43) Pub. Date: Sep. 17, 2020

(54) DATA SYNCHRONIZATION METHODS, APPARATUSES, AND DEVICES

(71) Applicant: Alibaba Group Holding Limited, George Town (KY)

(72) Inventor: Juan DU, Hangzhou (CN)

(73) Assignee: Alibaba Group Holding Limited, George Town (KY)

(21) Appl. No.: 16/886,568

(22) Filed: May 28, 2020

Related U.S. Application Data
(63) Continuation of application No. PCT/CN2019/073838, filed on Jan. 30, 2019.

(30) Foreign Application Priority Data
Apr. 4, 2018 (CN) 201810297307.0

(51) Int. Cl. G06F 16/178; G06F 12/0802

(52) U.S. Cl. CPC G06F 16/178; G06F 2212/60; G06F 12/0802

(57) ABSTRACT

An application is used to identify a data identifier associated with data to be queried. The application and the data identifier are used to identify data in a cache associated with the data identifier and a first version identifier corresponding to the data in the cache associated with the data identifier. In response to determining that the first version identifier does not match a second version identifier, the application is used to obtain data from a database associated with the data identifier, and the application is used to replace the data in the cache associated with the data identifier with the data from the database associated with the data identifier.

### CROSS-REFERENCE TO RELATED APPLICATIONS

This application is a continuation of PCT Application No. PCT/CN2019/073838, filed on Jan. 30, 2019, which claims priority to Chinese Patent Application No. 201810297307.0, filed on Apr. 4, 2018, and each application is hereby incorporated by reference in its entirety.

### TECHNICAL FIELD

The present specification relates to the field of computer technologies, and in particular, to data synchronization methods, apparatuses, and devices.

### BACKGROUND

To satisfy increasing data query needs of users, currently, some commonly used user data can be stored in a cache. As such, not only data query efficiency can be improved, but also database query pressure can be effectively alleviated, as shown in FIG. 1.

FIG. 1 is a schematic diagram illustrating data query performed by a user by using a server in the existing technology, according to the present specification.

For data value1 stored in the cache, after receiving a data query request that includes key1, the server can directly query the data value1 corresponding to key1 from the cache. For data value4 that is not stored in the cache, the server can query, from the cache by receiving key4 included in the data query request, whether data corresponding to key4 exists in the cache. If it is determined that the data corresponding to key4 is not stored in the cache, the data corresponding to key4 can be queried from a database, and further, the data value4 corresponding to key4 is obtained from the database. In addition, the server can store key4 and value4 in the cache based on a correspondence, so subsequently a user can quickly query the data corresponding to key4 from the cache.

In practice, there may be a case in which service data stored in the database changes, but service data stored in the cache does not change, as shown in FIG. 2.

FIG. 2 is a schematic diagram illustrating data stored in a database and a cache is inconsistent, according to the present specification.

For example, assume that verification information used to perform identity verification is not set for user 1 at first, user data value1 of user 1 stored in the database does not include verification information of the user, and the user data value1 stored in the cache also does not include the verification information of the user. However, as the user 1 has increasing identity verification needs, the user 1 can set, on the server, verification information used to perform identity verification. As such, the verification information of the user 1 is further stored as user data of the user 1, and the user data value1 is also changed to value1′ accordingly. However, the cache still stores value1. As a result, the server cannot perform identity verification on the user 1 by using the user data value1 obtained from the cache.

Based on the existing technology, an effective data synchronization method is needed.

### SUMMARY

The present specification provides data synchronization methods to alleviate a problem in the existing technology that data cannot be synchronized in a database and a cache.

The present specification provides a data synchronization method, including: determining, by an application, to-be-queried data; obtaining a version identifier corresponding to the to-be-queried data from a cache; and when it is determined that the version identifier corresponding to the to-be-queried data is inconsistent with a specified version identifier, querying the to-be-queried data from a database, and replacing the to-be-queried data stored in the cache with the to-be-queried data obtained from the database.

The present specification provides data synchronization apparatuses to alleviate a problem in the existing technology that data cannot be synchronized in a database and a cache.

The present specification provides a data synchronization apparatus, including: a determining module, configured to determine to-be-queried data; an acquisition module, configured to obtain a version identifier corresponding to the to-be-queried data from a cache; and a processing module, configured to: when it is determined that the version identifier corresponding to the to-be-queried data is inconsistent with a specified version identifier, query the to-be-queried data from a database, and replace the to-be-queried data stored in the cache with the to-be-queried data obtained from the database.

The present specification provides data synchronization devices to alleviate a problem in the existing technology that data cannot be synchronized in a database and a cache.

The present specification provides a data synchronization device, including one or more processors and a memory, where the memory stores a program, and the program is configured to be used by the one or more processors to perform the following steps: determining to-be-queried data; obtaining a version identifier corresponding to the to-be-queried data from a cache; and when it is determined that the version identifier corresponding to the to-be-queried data is inconsistent with a specified version identifier, querying the to-be-queried data from a database, and replacing the to-be-queried data stored in the cache with the to-be-queried data obtained from the database.

The at least one technical solution used in the present specification can achieve the following beneficial effects:

In one or more implementations of the present specification, the application can determine the to-be-queried data, obtain the version identifier corresponding to the to-be-queried data from the cache, query the to-be-queried data from the database when it is determined that the version identifier corresponding to the to-be-queried data is inconsistent with the specified version identifier, and replace the to-be-queried data stored in the cache with the to-be-queried data obtained from the database.

It can be understood from the previous method that whether the version identifier corresponding to the to-be-queried data stored in the cache is consistent with the specified version identifier can be compared, to determine whether the to-be-queried data stored in the cache is consistent with the to-be-queried data stored the database, and when it is determined that the two are inconsistent, data synchronization is performed, thereby effectively ensuring data consistency between the database and the cache.

### BRIEF DESCRIPTION OF DRAWINGS

The accompanying drawings described here are intended to provide a further understanding of the present disclosure, and constitute a part of the present disclosure. The illustrative implementations of the present disclosure and descriptions thereof are intended to describe the present disclosure, and do not constitute limitations on the present disclosure. In the accompanying drawings:

FIG. 1 is a schematic diagram illustrating data query performed by a user by using a server in the existing technology, according to the present specification;

FIG. 2 is a schematic diagram illustrating data stored in a database and a cache is inconsistent, according to the present specification;

FIG. 3 is a schematic diagram illustrating a data synchronization process, according to the present specification;

FIG. 4 is a schematic diagram in which an application obtains a version identifier corresponding to to-be-queried data from a cache, according to the present specification;

FIG. 5 is a schematic diagram illustrating a data synchronization apparatus, according to the present specification;

FIG. 6 is a schematic diagram illustrating a data synchronization device, according to the present specification.

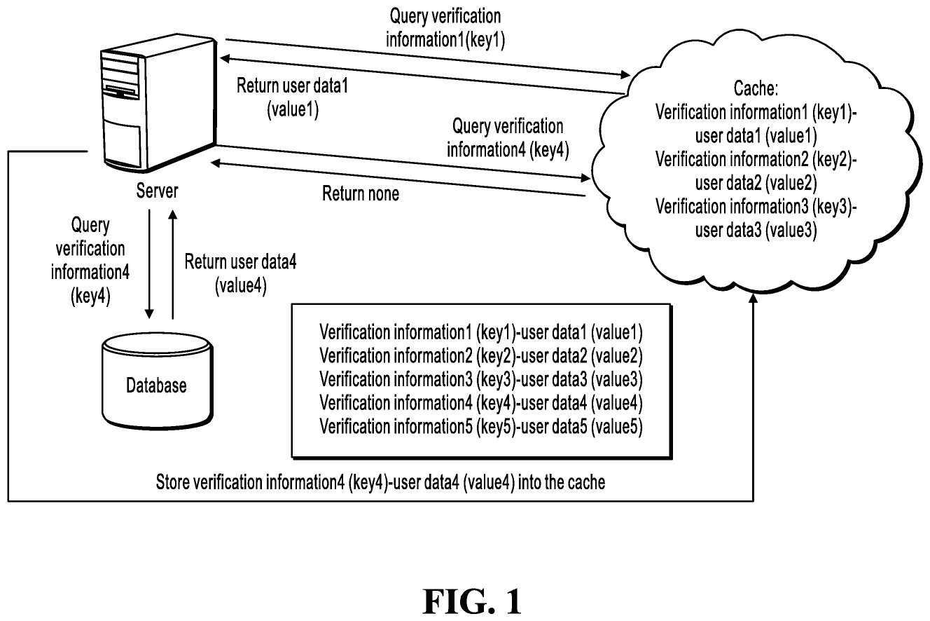

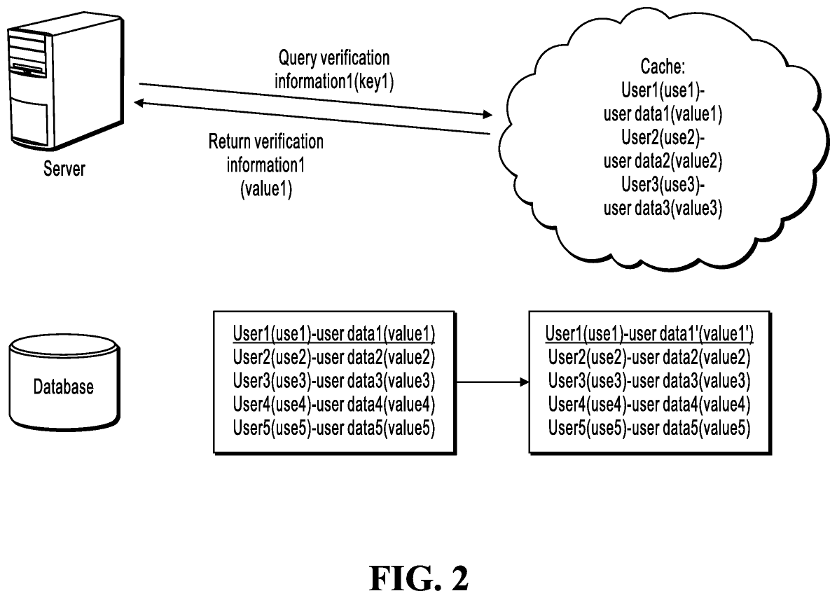

### DESCRIPTION OF IMPLEMENTATIONS

To make a person skilled in the art understand the technical solutions in one or more implementations of the present specification better, the following clearly and comprehensively describes the technical solutions in the one or more implementations of the present specification with reference to the accompanying drawings in the one or more implementations of the present specification. Clearly, the described implementations are merely some but not all of the implementations of the present specification. All other implementations obtained by a person of ordinary skill in the art based on the implementations of the present specification without creative efforts shall fall within the protection scope of the present specification.

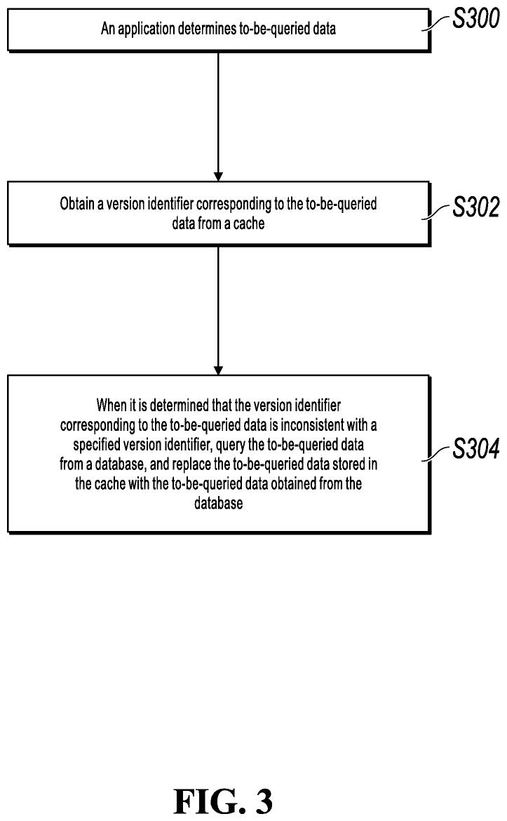

FIG. 3 is a schematic diagram illustrating a data synchronization process, according to the present specification. The process specifically includes the following steps.

S300. An application determines to-be-queried data.

In the present specification, the application can determine the to-be-queried data in a service execution process. The to-be-queried data can be determined by the application based on a data query request sent by a user, that is, the user needs to execute a data query service by using the application.

Certainly, the to-be-queried data can be data that needs to be queried when the application executes the service and that is determined in a process of processing the service request sent by the user. For example, the application can determine, based on a payment request (that is, the service request mentioned above) sent by the user, that in a process of processing a payment service corresponding to the payment request, account data of the user needs to be queried. The account data mentioned here is the previous to-be-queried data.

The application mentioned here can refer to a server application that can process the service executed by the user, or certainly can refer to a client installed on a terminal device such as a mobile phone or a computer. As services are continuously updated, service logic, data formats, etc. of the application used to execute the service process will change accordingly. Correspondingly, each time the application is updated, version information corresponding to the application also changes accordingly. In the present specification, in response to detecting a change to version information of the application, a specified version identifier can be determined based on the changed version information, so as to compare the specified version identifier with a version identifier corresponding to to-be-queried data that is subsequently obtained from a cache. In other words, the specified version identifier changes with an update of the application, and is changed to a version identifier corresponding to current version information of the application.

S302. Obtain a version identifier corresponding to the to-be-queried data from a cache.

After determining the to-be-queried data, the application can query data corresponding to a data identifier from the cache based on the data identifier corresponding to the determined to-be-queried data. The data identifier mentioned here is used to identify data that needs to be queried. For example, when data is stored in a key-value form in the cache, the key is a data identifier, and the value is data corresponding to the data identifier key. The cache mentioned here can be a distributed cache disposed in a service system.

The application can query the data corresponding to the data identifier from the cache by using the determined data identifier. If it is determined that the distributed cache stores the data (that is, the to-be-queried data) corresponding to the data identifier, a version identifier corresponding to the to-be-queried data can be obtained, where the version identifier can appear in a form of a version number, time information of a version change, etc.

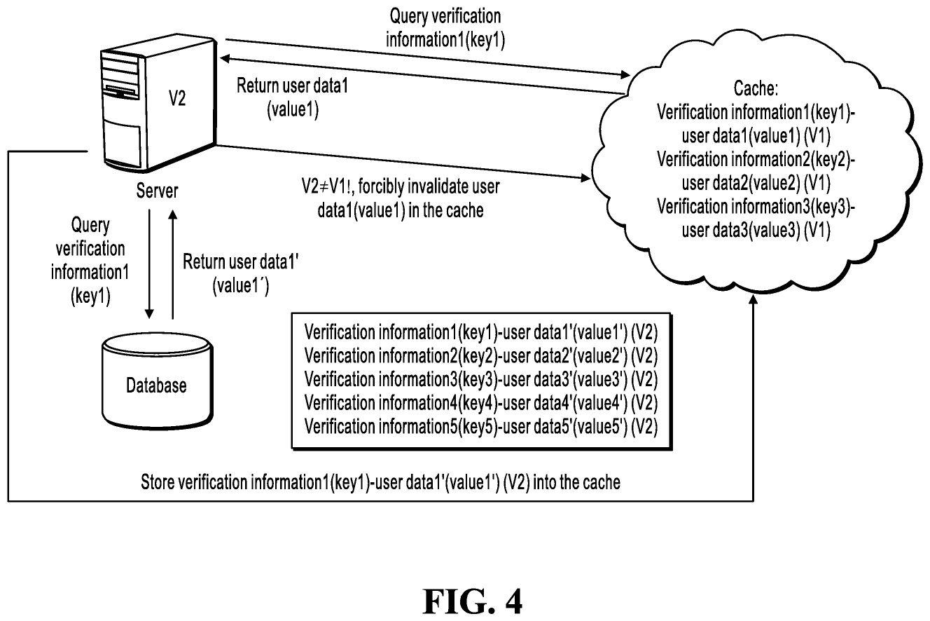

In the present specification, the version identifier can be included in the to-be-queried data stored in the cache. Correspondingly, the application can obtain the to-be-queried data corresponding to the data identifier from the cache based on the determined data identifier, and further obtain a version identifier corresponding to the to-be-queried data from the to-be-queried data, as shown in FIG. 4.

FIG. 4 is a schematic diagram in which an application obtains a version identifier corresponding to to-be-queried data from a cache, according to the present specification.

When data is stored in a key-value form in the cache, the application can query, from the cache based on a primary key of a query key1 corresponding to the to-be-queried data, a value value1 corresponding to key1, where value1 includes a version identifier V1. Therefore, the application can obtain a version identifier corresponding to value1 (that is, the to-be-queried data) from value1.

Certainly, in the present specification, the version identifier can be included in identification information corresponding to the data stored in the cache. Here, the identification information can be referred to as an actual identifier corresponding to the data stored in the cache. Correspondingly, after determining a data identifier corresponding to the to-be-queried data, the application can determine the actual identifier that matches the data identifier from the cache, and further obtain the version identifier corresponding to the to-be-queried data from the actual identifier.

For example, assume that the to-be-queried data value1 is stored in the cache in a form of key1_V1-value′, the actual identifier corresponding to the to-be-queried data value1 is key1_V1, and V1 is a version identifier included in the actual identifier. Therefore, the application can determine, based on the data identifier key1 corresponding to the to-be-queried data, the actual identifier key1_V1 that matches the data identifier key1 from the cache, and further determine the version identifier V1 corresponding to the to-be-queried data value1 from the actual identifier key1_V1.

S304. When it is determined that the version identifier corresponding to the to-be-queried data is inconsistent with a specified version identifier, query the to-be-queried data from a database, and replace the to-be-queried data stored in the cache with the to-be-queried data obtained from the database.

After obtaining the version identifier corresponding to the to-be-queried data from the cache, the application can compare the version identifier with the specified version identifier. When determining that the two version identifiers are inconsistent, the application can determine that the to-be-queried data stored in the database is not synchronous with the to-be-queried data stored in the cache, and further synchronizes the to-be-queried data stored in the database to the cache.

Specifically, when it is determined that the version identifier corresponding to the to-be-queried data obtained from the cache is inconsistent with the specified version identifier, the to-be-queried data stored in the cache can be invalidated, and the to-be-queried data obtained from the database is stored in the cache.

For example, in FIG. 4, a current version identifier of the application is V2, and the version identifier V2 can be used as the specified version identifier. In addition, a version identifier corresponding to each piece of data stored in the database is V2. After obtaining the version identifier V1 corresponding to the to-be-queried data value1 from the cache, if the application determines that the version identifier V1 does not match the specified version identifier V2, the application can forcibly invalidate, by using a predetermined instruction, the to-be-queried data V1 stored in the cache. In addition, the application can query data value1′ corresponding to the data identifier key1 from the database by using the data identifier key1 corresponding to the to-be-queried data, so as to obtain the data value1′ and store the value1′ in the cache.

That is, when it is determined that the version identifier corresponding to the to-be-queried data stored in the cache is inconsistent with the specified version identifier, the to-be-queried data stored in the cache is replaced with data that is stored in the database and whose version identifier is consistent with the specified version identifier, thereby completing data synchronization in the database and the cache.

Certainly, if it is determined that the version identifier corresponding to the to-be-queried data is consistent with the specified version identifier, it can be determined that the to-be-queried data stored in the database is synchronous with the to-be-queried data stored in the cache, and further the to-be-queried data stored in the cache can be directly obtained.

It can be understood from the previous that in the data synchronization method provided in the present specification, it is equivalent that, by using the version identifier of the data stored in the database as a reference to determine whether the version identifier of the data stored in the cache is consistent with the version identifier of the data stored in the database, so as to implement data synchronization in the database and the cache, thereby effectively ensuring data consistency between the database and the cache.

It is worthwhile to note that the previous specified version identifier can be a version identifier determined based on current version information of the application, or can be a version identifier corresponding to data stored in the current database. The version identifier corresponding to the current version information of the application can be consistent or can be inconsistent with the version identifier corresponding to the data stored in the database. However, regardless of whether the version identifier determined by using the current version information of the application is used as the specified version identifier, or the version identifier corresponding to the data stored in the database is used as the specified version identifier, if the version identifier of the to-be-queried data obtained from the cache is inconsistent with the specified version identifier, the to-be-queried data stored in the cache can be replaced with the to-be-queried data stored in the database, so the to-be-queried data is synchronized in the database and the cache.

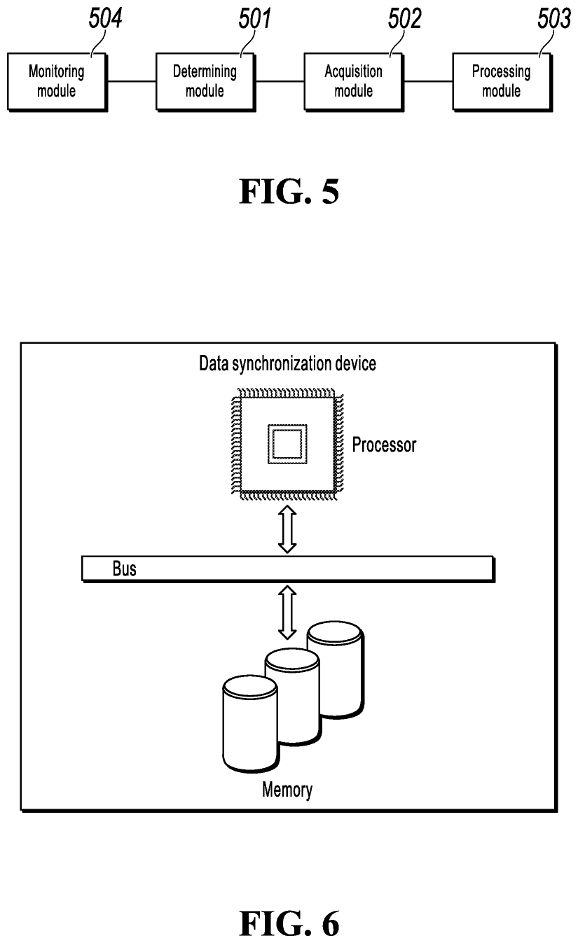

The previous describes the data synchronization methods provided in one or more implementations of the present specification. Based on the same idea, the present specification further provides a corresponding data synchronization apparatus, as shown in FIG. 5.

FIG. 5 is a schematic diagram illustrating a data synchronization apparatus, according to the present specification. The apparatus specifically includes: a determining module 501, configured to determine to-be-queried data; an acquisition module 502, configured to obtain a version identifier corresponding to the to-be-queried data from a cache; and a processing module 503, configured to: when it is determined that the version identifier corresponding to the to-be-queried data is inconsistent with a specified version identifier, query the to-be-queried data from a database, and replace the to-be-queried data stored in the cache with the to-be-queried data obtained from the database.

The processing module 503 is configured to: when it is determined that the version identifier corresponding to the to-be-queried data is consistent with the specified version identifier, obtain the to-be-queried data from the cache.

The determining module 501 determines a data identifier corresponding to the to-be-queried data; and the acquisition module 502 obtains to-be-queried data corresponding to the data identifier from the cache based on the determined data identifier; and obtains a version identifier corresponding to the to-be-queried data from the to-be-queried data.

The determining module 501 determines a data identifier corresponding to the to-be-queried data; and the acquisition module 502 determines an actual identifier that matches the data identifier from the cache; and obtains the version identifier corresponding to the to-be-queried data from the actual identifier.

The processing module 503 invalidates the to-be-queried data stored in the cache; and stores the to-be-queried data obtained from the database into the cache.

The apparatus further includes: a monitoring module 504, configured to: in response to detecting a change to version information of the apparatus, determine the specified version identifier based on changed version information.

Based on the previous data synchronization methods, the present specification further correspondingly provides a data synchronization device, as shown in FIG. 6. The device includes one or more processors and a memory. The memory stores a program, and the program is configured to be used by the one or more processors to perform the following steps: determining to-be-queried data; obtaining a version identifier corresponding to the to-be-queried data from a cache; and when it is determined that the version identifier corresponding to the to-be-queried data is inconsistent with a specified version identifier, querying the to-be-queried data from a database, and replacing the to-be-queried data stored in the cache with the to-be-queried data obtained from the database.

In one or more implementations of the present specification, the application can determine the to-be-queried data, obtain the version identifier corresponding to the to-be-queried data from the cache, query the to-be-queried data from the database when it is determined that the version identifier corresponding to the to-be-queried data is inconsistent with the specified version identifier, and replace the to-be-queried data stored in the cache with the to-be-queried data obtained from the database.

It can be understood from the previous method that whether the version identifier corresponding to the to-be-queried data stored in the cache is consistent with the specified version identifier can be compared, to determine whether the to-be-queried data stored in the cache is consistent with the to-be-queried data stored the database, and when it is determined that the two are inconsistent, data synchronization is performed, thereby effectively ensuring data consistency between the database and the cache.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, the programming is mostly implemented by modifying “logic compiler” software instead of manually making an integrated circuit chip. This is similar to a software compiler used for program development and compiling. However, original code before compiling is also written in a specific programming language, which is referred to as a hardware description language (HDL). There are many HDLs, such as an Advanced Boolean Expression Language (ABEL), an Altera Hardware Description Language (AHDL), Confluence, a Cornell University Programming Language (CUPL), HDCal, a Java Hardware Description Language (JHDL), Lava, Lola, MyHDL, PALASM, and a Ruby Hardware Description Language (RHDL). Currently, a Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The system, device, module, or unit illustrated in the previous implementations can be implemented by using a computer chip or an entity, or can be implemented by using a product having a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present specification is implemented, a function of each unit can be implemented in one or more pieces of software and/or hardware.

A person skilled in the art should understand that an implementation of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on one or more implementations of the present specification. It is worthwhile to note that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate a device for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or another programmable data processing device, so a series of operations and operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), one or more input/output interfaces, one or more network interfaces, and one or more memories.

The memory may include a non-persistent memory, a random access memory (RAM), a non-volatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can store information by using any method or technology. The information can be a computer readable instruction, a data structure, a program module, or other data. Examples of a computer storage medium include but are not limited to a phase change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage or another magnetic storage device. The computer storage medium can be used to store information accessible by the calculating device. Based on the definition in the present specification, the computer readable medium does not include transitory computer readable media (transitory media) such as a modulated data signal and carrier.

It is worthwhile to further note that, the terms “include”, “contain”, or their any other variants are intended to cover a non-exclusive inclusion, so a process, a method, a product or a device that includes a list of elements not only includes those elements but also includes other elements which are not expressly listed, or further includes elements inherent to such process, method, product or device. Without more constraints, an element preceded by “includes a . . . ” does not preclude the existence of additional identical elements in the process, method, product or device that includes the element.

The present specification can be described in the general context of computer-executable instructions, for example, a program module. Generally, the program module includes a routine, a program, an object, a component, a data structure, etc. executing a specific task or implementing a specific abstract data type. The one or more implementations of the present specification can also be practiced in distributed computing environments. In the distributed computing environments, tasks are performed by remote processing devices that are connected through a communications network. In a distributed computing environment, the program module can be located in both local and remote computer storage media including storage devices.

The implementations in the present specification are described in a progressive way. For same or similar parts of the implementations, references can be made to the implementations. Each implementation focuses on a difference from other implementations. Particularly, a system implementation is similar to a method implementation, and therefore is described briefly. For related parts, references can be made to related descriptions in the method implementation.

Specific implementations of the present specification are described above. Other implementations fall within the scope of the appended claims. In some situations, the actions or steps described in the claims can be performed in an order different from the order in the implementations and the desired results can still be achieved. In addition, the process depicted in the accompanying drawings does not necessarily need a particular execution order to achieve the desired results. In some implementations, multi-tasking and concurrent processing is feasible or may be advantageous.

The previous descriptions are merely one or more implementations of the present specification, and are not intended to limit the present specification. For a person skilled in the art, the one or more implementations of the present specification can have various modifications and changes. Any modifications, equivalent replacements, and improvements made within the spirit and principle of the one or more implementations of the present specification shall fall within the scope of the claims in the present specification.

What is claimed is:

1. A data synchronization method, comprising:
identifying, using an application, a data identifier associated with data to be queried;
identifying, using the application and the data identifier, data in a cache associated with the data identifier and a first version identifier corresponding to the data in the cache associated with the data identifier; and
in response to determining that the first version identifier does not match a second version identifier:
obtaining, using the application, data from a database associated with the data identifier; and
replacing, using the application, the data in the cache associated with the data identifier with the data from the database associated with the data identifier.

2. The method according to claim 1, further comprising:
in response to determining that the first version identifier matches the second version identifier, obtaining, using the application, the data in the cache associated with the data identifier.

3. The method according to claim 1, wherein identifying the first version identifier comprises:
obtaining, based on the data identifier, the data in the cache associated with the data identifier; and
identifying, from the data in the cache associated with the data identifier, the first version identifier.

4. The method according to claim 1, wherein identifying the first version identifier comprises:
identifying, in the cache, an actual identifier that matches the data identifier; and
identifying, from the actual identifier, the first version identifier.

5. The method according to claim 1, wherein replacing the data in the cache associated with the data identifier with the data from the database associated with the data identifier comprises:
invalidating the data in the cache associated with the data identifier; and
storing, in the cache, the data from the database associated with the data identifier.

6. The method according to claim 1, further comprising:
in response to detecting a change to version information of the application, determining the second version identifier based on changed version information.

7. The method according to claim 1, wherein the second version identifier is determined based on current version information of the application.

8. A non-transitory, computer-readable medium storing one or more instructions executable by a computer system to perform operations comprising:
identifying, using an application, a data identifier associated with data to be queried;
identifying, using the application and the data identifier, data in a cache associated with the data identifier and a first version identifier corresponding to the data in the cache associated with the data identifier; and
in response to determining that the first version identifier does not match a second version identifier:
obtaining, using the application, data from a database associated with the data identifier; and
replacing, using the application, the data in the cache associated with the data identifier with the data from the database associated with the data identifier.

9. The non-transitory, computer-readable medium according to claim 8, wherein the operations comprise:
in response to determining that the first version identifier matches the second version identifier, obtaining, using the application, the data in the cache associated with the data identifier.

10. The non-transitory, computer-readable medium according to claim 8, wherein identifying the first version identifier comprises:
obtaining, based on the data identifier, the data in the cache associated with the data identifier; and
identifying, from the data in the cache associated with the data identifier, the first version identifier.

11. The non-transitory, computer-readable medium according to claim 8, wherein identifying the first version identifier comprises:
identifying, in the cache, an actual identifier that matches the data identifier; and
identifying, from the actual identifier, the first version identifier.

12. The non-transitory, computer-readable medium according to claim 8, wherein replacing the data in the cache associated with the data identifier with the data from the database associated with the data identifier comprises:
invalidating the data in the cache associated with the data identifier; and
storing, in the cache, the data from the database associated with the data identifier.

13. The non-transitory, computer-readable medium according to claim 8, wherein the operations comprise:
in response to detecting a change to version information of the application, determining the second version identifier based on changed version information.

14. The non-transitory, computer-readable medium according to claim 8, wherein the second version identifier is determined based on current version information of the application.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
identifying, using an application, a data identifier associated with data to be queried;
identifying, using the application and the data identifier, data in a cache associated with the data identifier and a first version identifier corresponding to the data in the cache associated with the data identifier; and
in response to determining that the first version identifier does not match a second version identifier:
obtaining, using the application, data from a database associated with the data identifier; and
replacing, using the application, the data in the cache associated with the data identifier with the data from the database associated with the data identifier.

16. The computer-implemented system according to claim 15, wherein the operations comprise:
in response to determining that the first version identifier matches the second version identifier, obtaining, using the application, the data in the cache associated with the data identifier.

17. The computer-implemented system according to claim 15, wherein identifying the first version identifier comprises:
obtaining, based on the data identifier, the data in the cache associated with the data identifier; and
identifying, from the data in the cache associated with the data identifier, the first version identifier.

18. The computer-implemented system according to claim 15, wherein identifying the first version identifier comprises:
identifying, in the cache, an actual identifier that matches the data identifier; and
identifying, from the actual identifier, the first version identifier.

19. The computer-implemented system according to claim 15, wherein replacing the data in the cache associated with the data identifier with the data from the database associated with the data identifier comprises:
invalidating the data in the cache associated with the data identifier; and
storing, in the cache, the data from the database associated with the data identifier.

20. The computer-implemented system according to claim 15, wherein the operations comprise:
in response to detecting a change to version information of the application, determining the second version identifier based on changed version information.
